(19) United States
(12) Patent Application Publication
(10) Pub. No.: US 2012/0210627 A1
(43) Pub. Date: Aug. 23, 2012

(54) Bait Enhancer

(76) Inventor: Austin Troy Villhard, Ballwin, MO (US)

(21) Appl. No.: 13/401,615

(22) Filed: Feb. 21, 2012

Related U.S. Application Data
(60) Provisional application No. 61/444,933, filed on Feb. 21, 2011.

(51) Int. Cl. A01K 99/00; A01K 85/01; A01K 97/04; A01K 97/00

(52) U.S. Cl. 43/4.5; 43/44.99; 426/1

(57) ABSTRACT

Bait enhancer and methods of forming bait enhancer. Some embodiments provide bait enhancer comprising a first portion of red cabbage juice and a second portion containing at least one of a chemical selected from the group consisting of magnesium hydroxide, aluminum hydroxide and simethicone wherein the first portion and the second portion are mixed together and, perhaps, are believed to react to form a product. Optionally, the first and second portions can be about equal amounts by volume. Moreover, a 5 milliliter amount of the second portion can include about 200 milligrams of magnesium hydroxide, about 153 milligrams of the aluminum hydroxide and about 20 mg of the simethicone. In some embodiments the bait enhancer is applied to a fishing lure. Furthermore, the bait enhancer can be refrigerated at or less than about 45 degrees Fahrenheit.

### CROSS REFERENCE TO RELATED APPLICATIONS

This application claims priority to U.S. provisional patent application No. 61/444,933, filed on Feb. 21, 2011, by Austin Troy Villhard, entitled Stink Bait, and which is incorporated herein as if set forth in full.

### BACKGROUND

Fishing provides pleasure for many anglers and serves as a manner of obtaining food for those anglers and many others. However, anglers sometimes find themselves frustrated by the lack of fish at spots where they fish. Many solutions to this lack of “bites” have been proposed. For instance, some anglers use sonar-based fish finders to locate schools of fish. But such fish finders usually require that the angler be in a boat using it to move about a body of water while searching for fish with the fish finder. Thus, if the angler does not own or otherwise have a boat available, a fish finder is of little use.

Many strategies have been developed to place the angler in a location that is advantageous for catching fish. For instance, it has been observed that certain species of fish prefer certain locations within various bodies of water. Trout, in some cases, prefer to swim in or just below rapids where it is believed that they can more easily catch their own prey. Meanwhile bass and many other species of fish prefer deep or shaded water particularly if the area includes sunken trees which the fish use as shelter. Thus, if an angler can find one of these locations, the angler can often improve their luck. That is, they will be likely to catch more fish in these locations than others. On the other hand, if no such locations are readily apparent or happen to be already taken by other anglers, the angler may not be able to readily use these same locations.

Others have developed “bait enhancers” to attract the fish. These bait enhancers work by attracting fish to a lure with the scent (or colloquial “stink”) created by the fish bait. It is believed that the fish mistake the smell emanating from the bait enhancer and spreading through the water by diffusion and/or by mechanical transport where a current exists. Thus, the fish follow the scent of the bait enhancer back to its source. If, as is often the case, the angler has applied the bait enhancer to bait on a lure, the fish will bite the bait and become caught on a hook positioned in the bait (with the bait enhancer applied thereto). However, it is often the case that an angler might run out of bait enhancer and/or that the particular bait enhancer available might not be effective.

### SUMMARY

The following section presents a simplified summary in order to introduce some aspects of the disclosed subject matter. This summary is not an extensive overview of the disclosed subject matter, and is not intended to identify key or critical elements or to delineate the scope of such subject matter. A purpose of the summary is to present some concepts in a simplified form as a prelude to the more detailed disclosure that is presented herein.

Some embodiments provide bait enhancer comprising a first portion of red cabbage juice and a second portion containing at least one of a chemical selected from the group consisting of magnesium hydroxide, aluminum hydroxide and simethicone wherein the first portion and the second portion are mixed together and (are believed to) react to create the bait enhancer. Optionally, the first and second portions can be about equal amounts by volume. Moreover, a 5 milliliter amount of the second portion can include about 200 milligrams of magnesium hydroxide, about 153 milligrams of the aluminum hydroxide and about 20 mg of the simethicone. In some embodiments the bait enhancer is applied to a fishing lure. Furthermore, the bait enhancer can be refrigerated at or less than about 45 degrees Fahrenheit. Additionally, other embodiments provide methods of making bait enhancer.

To the accomplishment of the foregoing and related ends, certain illustrative aspects are described herein in connection with the figures. These aspects are indicative of various ways in which the disclosed subject matter may be practiced, all of which are intended to be within the scope of the disclosed subject matter without limiting the same. Other advantages and novel features may become apparent from the following detailed disclosure when considered in conjunction with the figures.

### BRIEF DESCRIPTION OF THE FIGURES

The detailed description is described with reference to the accompanying figures. In these figures, the same left-most digit(s) of reference numbers usually indicates that these reference numbers appear for the first time in this document on the same figure. The use of similar reference numbers in different figures usually indicates similar or identical items.

FIG. 1 illustrates anglers fishing.

FIG. 2 illustrates fish being attracted to a bait enhanced lure.

FIG. 3 illustrates a method of making bait enhancer.

### DETAILED DESCRIPTION

This document discloses bait enhancers for angling and more particular bait enhancers formed from red cabbage juice and common antacids.

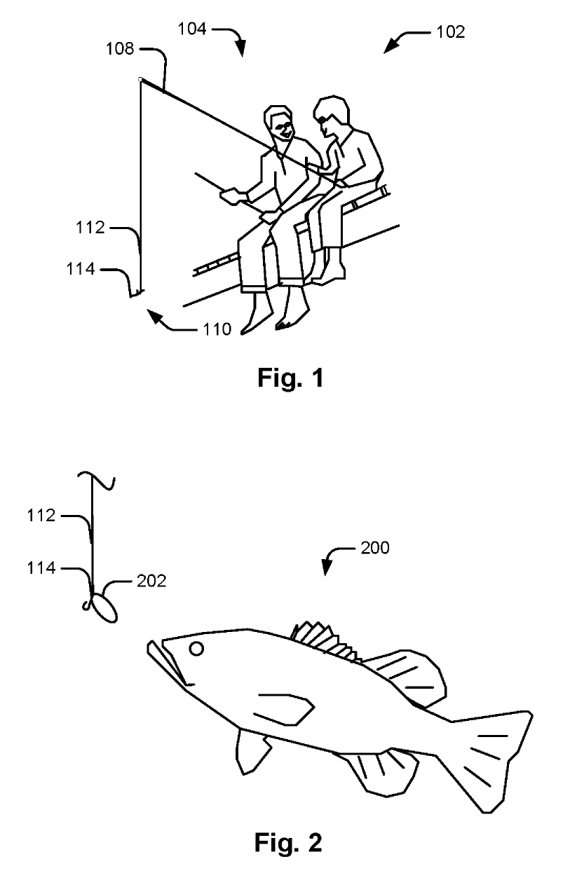

FIG. 1 illustrates anglers fishing. More particularly, FIG. 1 illustrates several anglers 102 and 104 using fishing poles 108 to fish. Typically, anglers apply hooks 110 to the lines 112. They then place bait 114 on the hooks 110 and cast, drop, or otherwise place the baited hook into the water. The bait 114 comes in a wide variety and includes various types of worms, insects, maggots, minnows, larger fish, etc. and other types of live bait. Of course, the bait 114 can be dead or can even be pieces of the foregoing illustrative types of bait 114. On the other hand, anglers 102 sometimes use fishing lures instead of bait 114.

FIG. 2 illustrates fish being attracted to a bait enhanced lure. Fishing lures are objects which are often created in such a way as to look like certain types of bait 114 and/or to mimic the behavior of prey upon which fish 200 feed. For instance, a spinner is a type of lure with a shiny surface on one or more surfaces thereof. When pulled through the water by a line 112, the spinner spins thereby causing the reflective surface to create flashes of light which attracts certain types of fish 200. However, bait 114 and fishing lures sometimes fail to attract fish 200 or enough fish to make the fishing experience enjoyable and/or productive for the angler 102. Thus, it might be beneficial in some circumstances to apply bait enhancer to the bait 114 and/or the fishing lure.

In the scenario illustrated by FIG. 2 a portion of the bait 114 has had bait enhancer 202 of the current embodiment applied to it. As described elsewhere herein, a scent emanates from the bait enhancer 202 and attracts the fish 200 to the source of the scent. In the case illustrated by FIG. 2, the source of the scent is the bait 114 with the bait enhancer 202 applied thereto. More particularly, it has been found that an effective bait enhancer can be formed by mixing red cabbage juice and the following chemicals: magnesium hydroxide, aluminum hydroxide and simethicone in various combinations. For instance, in one embodiment, 5 millimeters of red cabbage juice is mixed with a 5 milliliter amount of a mixture containing about 200 milligrams of magnesium hydroxide, about 153 milligrams of the aluminum hydroxide and about 20 mg of the simethicone. Some amount of water can also be included in the mixture (magnesium hydroxide, aluminum hydroxide and simethicone hereinafter “antacids”) if desired to, for instance, bring the volume up to about 5 milliliters. In other words, bait enhancer 202 can be formed by mixing about equal portions of red cabbage juice and the mixture of magnesium hydroxide, aluminum hydroxide and simethicone. Of course, in some embodiments one or more of the magnesium hydroxide, the aluminum hydroxide and the simethicone react with a constituent of the red cabbage juice to form a product which can then be used as bait enhancer.

Indeed, it has been found that the bait enhancer of the current embodiment was effective in catching fish in several disparate locations. For instance, the inventor using a common fishing pole/reel combination caught approximately 3 dozen fish 200 in less than an hour at a pond located in Vlassis Park in Ballwin Mo. in June, 2010. The fish 200 caught included catfish, bass, and blue gill and other sun fish. Moreover, that angler 102 tested the bait enhancer 202 of the current embodiment from the end of the west most pier in Emma Long Metropolitan Park in Austin, Tex. one afternoon in July 2010. During the test, the angler used plain bait 114 for approximately 30 minutes and caught no fish. Using the same techniques and bait 114, the angler then caught approximately 2 dozen fish in the next thirty minutes. Thus, bait enhancer 114 of the current embodiment has demonstrated success for use in attracting and catching fish 200.

In other embodiments, though, unequal amounts of red cabbage juice and the mixture of magnesium hydroxide, aluminum hydroxide and simethicone can be used to form bait enhancer 114. Indeed, bait enhancer 114 can be formed by using only one or the other of the magnesium hydroxide, aluminum hydroxide or simethicone or various combinations thereof. In the alternative, or in addition, these chemicals can be used in amounts and/or concentrations other than the illustrative amounts and/or concentrations disclosed herein. However, the mixture of 200 milligrams of magnesium hydroxide, about 153 milligrams of the aluminum hydroxide and about 20 mg of the simethicone per about 5 milliliters is found in the commercially available antacid Maalox®. As of this writing, Novartis Consumer Health, Inc. makes Maalox® and offers it in over the counter versions in a wide number of commercial outlets. Red cabbage juice is found in numerous grocery stores or can be extracted from red cabbage leafs.

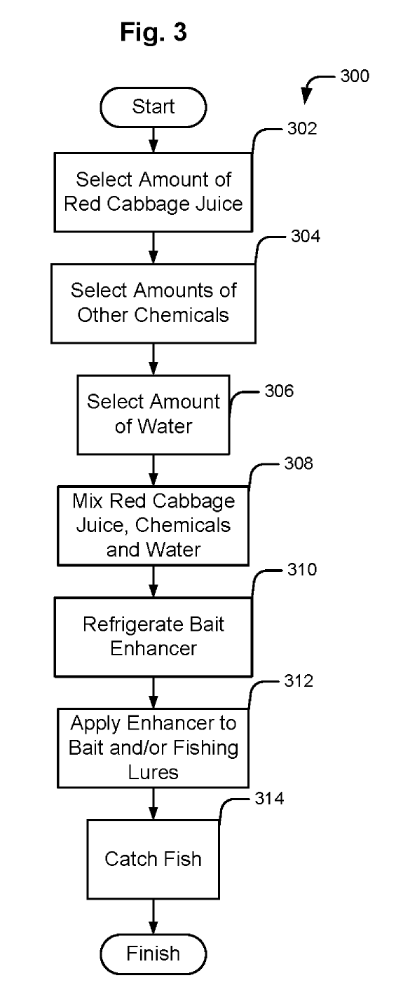

FIG. 3 illustrates a method of making bait enhancer. The method 300 of the current embodiment can include selecting an amount of red cabbage juice to use in forming bait enhancer 202. For instance, one teaspoon of red cabbage juice can be selected. See reference 302. FIG. 3 also illustrates that the method can include selecting other chemicals for use in forming bait enhancer 202. In the current embodiment, 200 milligrams of magnesium hydroxide, about 153 milligrams of the aluminum hydroxide and about 20 mg of the simethicone can be selected. In some embodiments, 5 milliliters of Maalox® is selected for forming bait enhancer 202. See reference 304. Some amount of water (for instance, about 5 milliliters) can be selected for inclusion in bait enhancer 202 depending on how thick/thin the user desires the bait enhancer to be as illustrated at reference 306.

Reference 308 illustrates that the water, red cabbage juice, and other chemical(s) can be mixed together to form bait enhancer 202. It might be useful to note that as soon as the mixing begins the bait enhancer 202 will begin emanating a pungent odor. Moreover, it has been found that the mixing can be performed at a fishing location or can be performed beforehand for subsequent use. However, to help preserve its effectiveness the bait enhancer 202 of the current embodiment can be refrigerated at a relatively low temperature. For instance, bait enhancer 202 of the current embodiment can be stored at about 45 degrees Fahrenheit for many weeks without losing its effectiveness. See reference 310.

At some time, the bait enhancer 202 of the current embodiment can be applied to bait 114 or a lure as might be desired. In some embodiments it can be helpful to apply the bait enhancer 202 to absorbent bait 114 or lures. Using the bait enhanced bait 114 (or lure) a user can then catch fish 202 as desired. See reference 314. Moreover, all or portions of method 300 can be repeated as desired and/or greater or lesser amounts of the various materials can be used in forming bait enhancer 202 without departing from the disclosure.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts disclosed above are disclosed as non-limiting forms of implementing the claimed subject matter.

1. Bait enhancer comprising:
a first portion of red cabbage juice; and
a second portion of a mixture of magnesium hydroxide, aluminum hydroxide and simethicone wherein the first portion and the second portion are mixed together.

2. The bait enhancer of claim 1 wherein the first portion and the second portion are about equal amounts by volume of the red cabbage juice and the mixture of magnesium hydroxide, aluminum hydroxide and simethicone.

3. The bait enhancer of claim 1 wherein a 5 milliliter amount of the second portion includes about 200 milligrams of magnesium hydroxide, about 153 milligrams of the aluminum hydroxide and about 20 mg of the simethicone.

4. The bait enhancer of claim 1 wherein the bait enhancer is applied to a fishing lure.

5. Bait enhancer comprising:
a first portion of red cabbage juice; and
a second portion containing at least one of a chemical selected from the group consisting of magnesium hydroxide, aluminum hydroxide and simethicone wherein the first portion and the second portion are mixed together.

6. The bait enhancer of claim 5 wherein the second portion contains magnesium hydroxide, aluminum hydroxide and simethicone.

7. A method of making bait enhancer comprising:
selecting a first portion of red cabbage juice;
selecting a second portion containing at least one of a chemical selected from the group consisting of magnesium hydroxide, aluminum hydroxide and simethicone; and
mixing the first portion and the second portion together to form the bait enhancer

8. The method of claim 7 further wherein the mixture of the first and second portions contains about equal amounts by volume of the first and second portions.

9. The method of claim 7 wherein a 5 milliliter amount of the second portion includes about 200 milligrams of magnesium hydroxide, about 153 milligrams of the aluminum hydroxide and about 20 mg of the simethicone.

10. The method of claim 7 further comprising maintaining a temperature of the mixture at or below about 45 degrees prior to using the mixture.

11. The method of claim 7 further comprising applying the bait enhancer to a fishing lure.

12. Bait enhancer comprising:
a product of a reaction between:
a first portion of red cabbage juice; and
a second portion containing at least one of a chemical selected from the group consisting of magnesium hydroxide, aluminum hydroxide and simethicone.
